(19) United States
(12) Patent Application Publication
(10) Pub. No.: US 2008/0175695 A1
(43) Pub. Date: Jul. 24, 2008

(54) OBJECT GRASPING ASSEMBLY

(76) Inventors: RICHARD D. HART, Nashua, NH (US); Brian T. Hart, Bedford, MA (US); Arthur A. Berube, Hampstead, NH (US)

Correspondence Address: HOLLAND & KNIGHT LLP, 10 ST. JAMES AVENUE, 11th Floor, BOSTON, MA, 02116-3889, US

(21) Appl. No.: 11/972,748

(22) Filed: Jan. 11, 2008

Related U.S. Application Data
(60) Provisional application No. 60/886,129, filed on Jan. 23, 2007.

(51) Int. Cl. B65H 1/00; B65G 69/00

(52) U.S. Cl. 414/222.01; 414/679

(57) ABSTRACT

An object grasping assembly for use on a vehicle includes a fixed jaw assembly. A flexible strapping assembly includes a first distal end and a second distal end. The flexible strapping assembly is configured to be positioned about at least a portion of the periphery of an object to be grasped. An actuator assembly is configured to releasably affix the object to the fixed jaw assembly by releasably engaging at least one of the first and second distal ends and tensioning the flexible strapping assembly.

### CROSS-REFERENCE TO RELATED APPLICATION

This application claims the benefit of U.S. provisional patent application Ser. No. 60/886,129, filed 23 Jan. 2007, the entire disclosure of which is incorporated herein by reference.

### TECHNICAL FIELD

This disclosure relates to object grasping assemblies and, more particularly, to object grasping assemblies that include a flexible grasping strap.

### BACKGROUND

Vehicles are often used to transport objects. In order to facilitate the delivery of such object, vehicles are often configured to allow for simplified delivery of such objects. For example, dumps trucks having tilting beds that automate the unloading process. Pay loaders having tilting buckets that allow for the easy loading and unloading of content.

The popularity of unmanned vehicles is increasing, especially in the area of performing hazardous/redundant duties. For example, unmanned vehicles may be used to perform routine security operations, such as patrolling the perimeter of a warehouse. Further, unmanned vehicles may be used in hazardous areas of operation, such as military and domestic security operations.

Often, these unmanned vehicles may be required to deliver objects to remote and often hazardous locations. Accordingly, an object delivery means may be required to facilitate the reliable and efficient delivery of such objects.

### SUMMARY OF THE DISCLOSURE

In one implementation, an object grasping assembly for use on a vehicle includes a fixed jaw assembly. A flexible strapping assembly includes a first distal end and a second distal end. The flexible strapping assembly is configured to be positioned about at least a portion of the periphery of an object to be grasped. An actuator assembly is configured to releasably affix the object to the fixed jaw assembly by releasably engaging at least one of the first and second distal ends and tensioning the flexible strapping assembly.

One or more of the following features may also be included. The vehicle may be an unmanned vehicle. The unmanned vehicle may be a law enforcement/military unmanned vehicle. The actuator assembly may be an electric actuator assembly. The actuator assembly may include at least one reel assembly. The flexible strapping assembly may include a pin assembly positioned proximate at least one of the first and second distal ends. The pin assembly may be configured to releasably engage the at least one reel assembly. The actuator assembly may be configured to rotate the at least one reel assembly when energized to wind at least a portion of the flexible strapping assembly about the reel assembly and tension the flexible strapping assembly. The flexible strapping assembly may be chosen from the group consisting of: a nylon flexible strapping assembly; a rubber flexible strapping assembly, a chain flexible strapping assembly, and a Kevlar flexible strapping assembly. The object to be grasped may be an explosive device.

In another implementation, an unmanned vehicle includes: a chassis assembly; a plurality of drive axle assemblies; a roll cage assembly; and an object grasping assembly. The object grasping assembly includes a fixed jaw assembly affixed to the chassis assembly. A flexible strapping assembly includes a first distal end and a second distal end. The flexible strapping assembly is configured to be positioned about at least a portion of the periphery of an object to be grasped. An actuator assembly is configured to releasably affix the object to the fixed jaw assembly by releasably engaging at least one of the first and second distal ends and tensioning the flexible strapping assembly.

One or more of the following features may also be included. The unmanned vehicle may be a law enforcement/military unmanned vehicle. The actuator assembly may be an electric actuator assembly. The actuator assembly may include at least one reel assembly. The flexible strapping assembly may include a pin assembly positioned proximate at least one of the first and second distal ends. The pin assembly may be configured to releasably engage the at least one reel assembly. The actuator assembly may be configured to rotate the at least one reel assembly when energized to wind at least a portion of the flexible strapping assembly about the reel assembly and tension the flexible strapping assembly. The flexible strapping assembly may be chosen from the group consisting of: a nylon flexible strapping assembly; a rubber flexible strapping assembly, a chain flexible strapping assembly, and a Kevlar flexible strapping assembly. The object to be grasped may be an explosive device.

In another implementation, an object grasping assembly for use on a vehicle includes a fixed jaw assembly. A flexible strapping assembly, which is configured to be positioned about at least a portion of the periphery of an object to be grasped, includes: a first distal end; a second distal end; a first pin assembly positioned proximate the first distal end; and a second pin assembly positioned proximate the second distal end. An actuator assembly is configured to releasably affix the object to the fixed jaw assembly. The actuator assembly includes: a first reel assembly configured to releasably engage the first pin assembly; and a second reel assembly configured to releasably engage the second pin assembly.

One or more of the following features may also be included. The vehicle may be an unmanned vehicle. The unmanned vehicle may be a law enforcement/military unmanned vehicle. The actuator assembly may be an electric actuator assembly. The actuator assembly may be configured to rotate the first and second reel assemblies when energized to wind at least a portion of the flexible strapping assembly about the reel assemblies and tension the flexible strapping assembly about the object. The flexible strapping assembly may be chosen from the group consisting of: a nylon flexible strapping assembly; a rubber flexible strapping assembly, a chain flexible strapping assembly, and a Kevlar flexible strapping assembly. The object to be grasped may be an explosive device.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a first isometric view of an unmanned vehicle incorporating an object grasping assembly;

FIG. 2 is a second isometric view of the object grasping assembly of FIG. 1;

FIG. 3 is a third isometric view of the object grasping assembly of FIG. 1;

FIG. 4 is a fourth isometric view of the object grasping assembly of FIG. 1; and

FIG. 5 is a fifth isometric view of the object grasping assembly of FIG. 1.

### DETAILED DESCRIPTION OF THE PREFERRED EMBODIMENTS

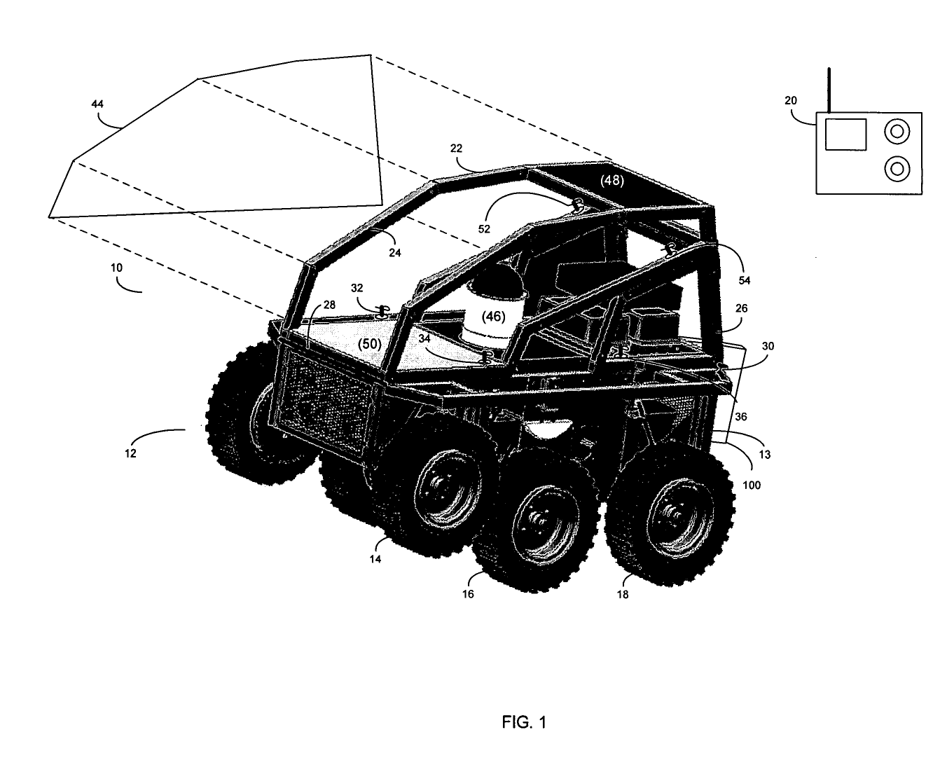

Referring to FIG. 1, there is shown roll cage assembly 10 installed on vehicle 12. Vehicle 12 may be a manned or unmanned vehicle for on or off road use. Examples of vehicle 12 may include, but are not limited to: dune buggies; all terrain vehicles; motorcycles; remotely-controlled vehicles, manned/unmanned military vehicles, manned/unmanned law enforcement vehicles, manned/unmanned patrol vehicles, manned/unmanned security vehicles, and manned/unmanned surveillance vehicles.

Vehicle 12 may include chassis 13 and a plurality of drive axle assemblies. For example, in the embodiment shown in FIG. 1, vehicle 12 is shown to include three drive axle assemblies 14, 16, 18 and is configured in a skid-steer arrangement (i.e., a vehicle that steers by rotating the wheels on one side of the vehicle at a different rate than the wheels on the other side of the vehicle. However, the number and type of wheel assemblies may be varied depending on the particular type of vehicle and the intended use of the vehicle. As discussed above, vehicle 12 may be an unmanned vehicle and, therefore, may be controlled via a remote transceiver 20 capable of providing control signals to and receiving data signals from vehicle 12.

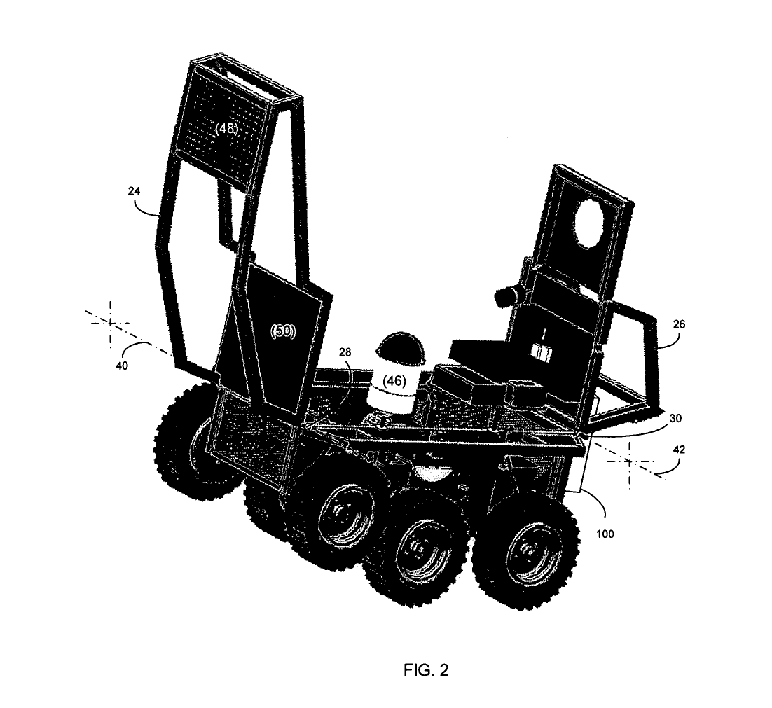

Referring also to FIG. 2, roll cage assembly 10 may include one or more structural components (e.g., structural component 22) that are rigidly assembled to form one or more roll cage assembly portions 24, 26. Examples of the structural components include, but are not limited to: square tube assemblies; round tube assemblies; and rectangular tube assemblies, which may be constructed of various materials (e.g., mild steel, and chromium-molybdenum steel).

Roll cage assembly 10 may include one or more roll cage displacement assemblies 28, 30, 32, 34, 36, each of which may be coupled to the one or more structural components and the vehicle. Each of the roll cage displacement assemblies 28, 30, 32, 34, 36 may be configured to allow for displacement of the one or more structural components (and, therefore, the one or more roll cage assembly portions 24, 26) with respect to vehicle 12, thus allowing access to the various devices (e.g., electric motors, batteries, controllers, transceiver circuitry, etc.) included within vehicle 12.

One or more of the roll cage displacement assemblies 28, 30, 32, 34, 36 may include one or more pivoting assemblies that allow at least a portion of the structural components to pivot with respect to vehicle 12. For example and in the embodiment shown in FIGS. 1 & 2, roll cage displacement assembly 28 is shown to be a hinge assembly that allows roll cage assembly portion 24 to pivot about axis 40. Further, roll cage displacement assembly 30 is shown to be a hinge assembly that allows roll cage assembly portion 26 to pivot about axis 42.

Roll cage assembly 10 may include one or more armored panel assemblies (e.g., armored panel 44) coupled to one or more of the structural components (e.g., structural component 22). The armored panel assemblies may be configured to protect vehicle 12 from attack. Accordingly, the armored panel assemblies may be positioned about the periphery of vehicle 12 to protect the sensitive/vulnerable devices (e.g., laser sensor 46) positioned within vehicle 12. The armored panel assemblies may be constructed of a material strong enough to provide the required level of protection, such as: plate steel; Kevlar; and reactive armor material.

Roll cage assembly 10 may include one or more protective panel assemblies (e.g., protective panel assemblies 48, 50) coupled one or more of the structural components (structural component 22). The protective panel assemblies may be configured to shield devices (e.g., electric motors, batteries, controllers, transceiver circuitry, etc.) included within vehicle 12 from e.g., mud, snow, and rain. The protective panel assemblies may be constructed of various materials, such as steel metal; plate steel; and plastic.

One or more of the roll cage displacement assemblies 28, 30, 32, 34, 36 may include one or more toolless mounting assemblies for releasably coupling at least a portion of the one or more structural components to the vehicle. For example and in the embodiment shown in FIGS. 1 & 2, roll cage displacement assemblies 32, 34 are shown to be pin assemblies configured to releasably couple roll cage assembly portion 24 to vehicle 12. Further, roll cage displacement assembly 36 is shown to be a pin assembly configured to releasably couple roll cage assembly portion 26 to vehicle 12. Additionally, roll cage assembly 10 may include one or more pin assemblies 52, 54 for e.g., releasably coupling roll cage assembly portion 24 to roll cage assembly portion 26, thus maintaining roll cage assembly 10 (which includes roll cage assembly portion 24 and roll cage assembly portion 26) in a “closed” position.

While toolless mounting assemblies are shown to be pin assemblies, other configurations are possible and are considered to be within the scope of this disclosure. For example, an alternative embodiment of the toolless mounting assembly may include, but is not limited to, a bolt and wing nut assembly.

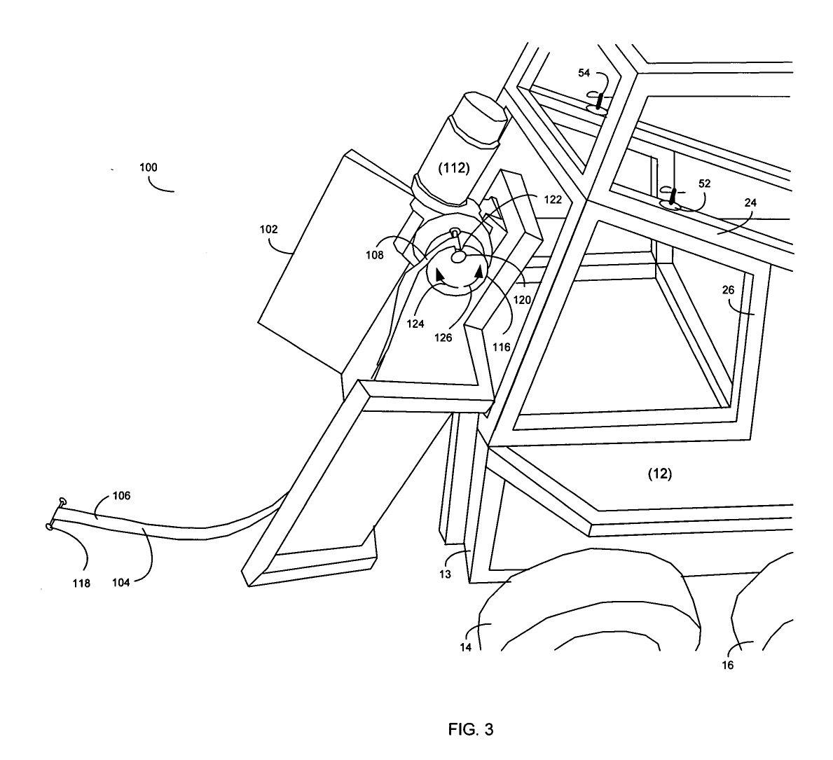

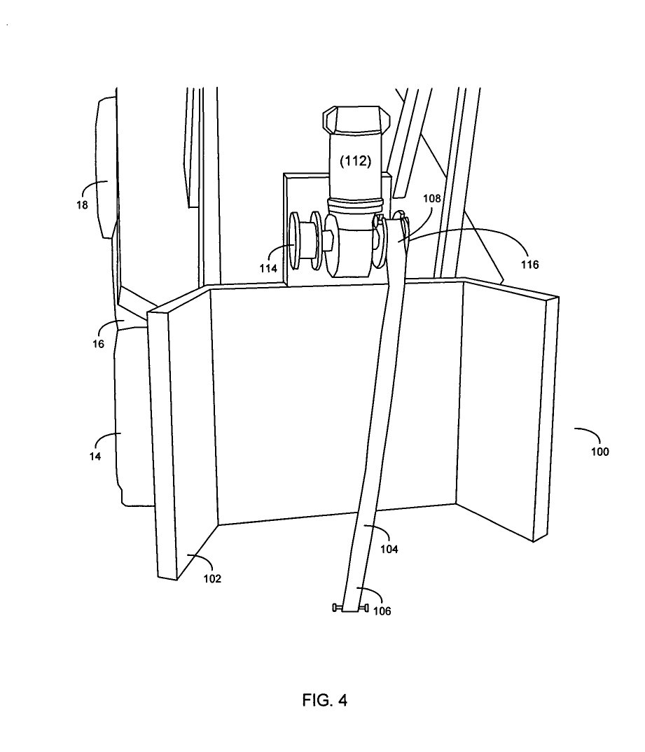

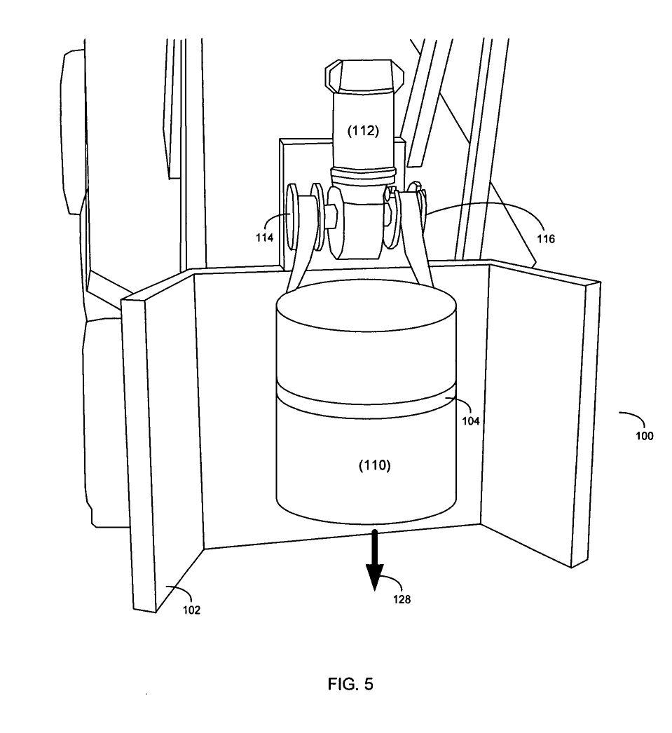

Referring also to FIGS. 3-5, vehicle 12 may include an object grasping assembly 100, which may be attached to chassis 13 of vehicle 12. Object grasping assembly 100 may include fixed jaw assembly 102. Fixed jaw assembly 102 may be constructed of a combination of a rigid framing material (e.g., square tube steel, round tube steel, or rectangular tube steel, for example) and a high friction planar material (e.g., expanded metal mesh). Object grasping assembly 100 may include a flexible strapping assembly 104 having a first distal end 106 and a second distal end 108. Flexible strapping assembly 104 may be configured to be positioned about at least a portion of the periphery of an object 110 to be grasped. Examples of flexible strapping assembly 104 may include, but are not limited to, a nylon flexible strapping assembly; a rubber flexible strapping assembly, a chain flexible strapping assembly, and a Kevlar flexible strapping assembly, for example. Examples of object 110 may include, but are not limited to, explosive devices, medial supplies, food supplies, ammunition, and medical equipment, for example. Actuator assembly 112 may be configured to releasably affix object 110 to fixed jaw assembly 102 by releasably engaging at least one of the first and second distal ends 106, 108 of flexible strapping assembly 104 and tensioning flexible strapping assembly 104 around object 110.

Actuator assembly 112 may be an electric actuator assembly. Accordingly, actuator assembly 112 may be configured to be energized by one or more battery assemblies (not shown) included within vehicle 12. Actuator assembly 112 may include one or more reel assemblies (e.g., reel assemblies 114, 116). Flexible strapping assembly 104 may include a first pin assembly 118 positioned proximate first distal end 106 and/or a second pin assembly 120 positioned proximate second distal end 108. Pin assembly 118 may be configured to releasably engage reel assembly 114; and/or pin assembly 120 may be configured to releasably engage reel assembly 116. Alternatively, one of distal ends 106, 108 may be affixed to e.g., fixed jaw assembly 102 and the other of distal ends 106, 108 may releasably engage one of reel assemblies 114, 116 (respectively).

Concerning the manner in which pin assemblies 118, 120 releasably engage reel assemblies 114, 116, in the embodiment shown in FIGS. 3-5, reel assembly 114 and/or reel assembly 116 may contain one or more notches. For example, reel assembly 116 is shown to include notch 122 into which pin assembly 120 is placed. Actuator assembly 112 may be configured to rotate reel assembly 114 and/or reel assembly 116 to either increase or decrease the tension of flexible strapping assembly 104 around object 110. For example, assume that reel assembly 114 also includes a notch (not shown) into which pin assembly 106 may be placed. Accordingly, object 110 may be positioned proximate fixed jaw assembly 102 and flexible strapping assembly 104 may be wrapped about the periphery of object 110. Pin assembly 106 may then be placed into the notch (not shown) within reel assembly 114 and pin assembly 120 may be placed within notch 122 of reel assembly 116. Actuator assembly 112 may be energized (using e.g., an onboard switch (not shown) and/or remote transceiver 20) to rotate reel assemblies 114, 116 clockwise (i.e., in the direction of arrow 124) to wind a portion of flexible strapping assembly 104 around reel assemblies 114, 116 and tighten flexible strapping assembly 104 around the periphery of object 110, thus frictionally affixing object 110 to fixed jaw assembly 102.

Vehicle 12 may then be driven to the destination of object 110. Upon arriving at the destination of object 110, actuator assembly 112 may be energized (using e.g., an onboard switch (not shown) and/or remote transceiver 20) to rotate reel assemblies 114, 116 counterclockwise (i.e., in the direction of arrow 126) to unwind flexible strapping assembly 104 from reel assemblies 114, 116 and loosen flexible strapping assembly 104 around the periphery of object 110, thus allowing object 110 to slide in a downward direction (i.e., in the direction of arrow 128). Once properly placed, vehicle 12 may return to its original location.

While roll cage assembly 10 is described above as including one or more pivoting assemblies that allow at least a portion of the structural components of roll cage assembly 10 to pivot with respect to vehicle 12, other configurations are possible and are considered to be within the scope of this disclosure. For example, all roll cage displacement assemblies may be toolless mounting assemblies for releasably coupling at least a portion of the one or more structural components to the vehicle. Therefore, the entire roll cage assembly 10 may be releasably coupled to vehicle 12. Accordingly, roll cage assembly 10 may be a single or multi-piece roll cage assembly that is releasably coupled to vehicle 12 using e.g., pin assemblies. Upon removal of these pin assemblies, the entire roll cage assembly 10 (or a portion thereof) may be removed from vehicle 12, thus allowing for access to the various devices (e.g., electric motors, batteries, controllers, transceiver circuitry, etc.) included within vehicle 12.

A number of implementations have been described. Nevertheless, it will be understood that various modifications may be made. Accordingly, other implementations are within the scope of the following claims.

What is claimed is:

1. An object grasping assembly for use on a vehicle, the object grasping assembly comprising:
a fixed jaw assembly;
a flexible strapping assembly including a first distal end and a second distal end and configured to be positioned about at least a portion of the periphery of an object to be grasped; and
an actuator assembly configured to releasably affix the object to the fixed jaw assembly by releasably engaging at least one of the first and second distal ends and tensioning the flexible strapping assembly.

2. The object grasping assembly of claim 1 wherein the vehicle is an unmanned vehicle.

3. The object grasping assembly of claim 2 wherein the unmanned vehicle is a law enforcement/military unmanned vehicle.

4. The object grasping assembly of claim 1 wherein the actuator assembly is an electric actuator assembly.

5. The object grasping assembly of claim 1 wherein:
the actuator assembly includes at least one reel assembly; and
the flexible strapping assembly includes a pin assembly positioned proximate at least one of the first and second distal ends.

6. The object grasping assembly of claim 5 wherein:
the pin assembly is configured to releasably engage the at least one reel assembly; and
the actuator assembly is configured to rotate the at least one reel assembly when energized to wind at least a portion of the flexible strapping assembly about the reel assembly and tension the flexible strapping assembly.

7. The object grasping assembly of claim 1 wherein the flexible strapping assembly is chosen from the group consisting of: a nylon flexible strapping assembly; a rubber flexible strapping assembly, a chain flexible strapping assembly, and a Kevlar flexible strapping assembly.

8. The object grasping assembly of claim 1 wherein the object to be grasped is an explosive device.

9. An unmanned vehicle comprising:
a chassis assembly;
a plurality of drive axle assemblies;
a roll cage assembly; and
an object grasping assembly including:
a fixed jaw assembly affixed to the chassis assembly;
a flexible strapping assembly including a first distal end and a second distal end and configured to be positioned about at least a portion of the periphery of an object to be grasped; and
an actuator assembly configured to releasably affix the object to the fixed jaw assembly by releasably engaging at least one of the first and second distal ends and tensioning the flexible strapping assembly.

10. The unmanned vehicle of claim 9 wherein the unmanned vehicle is a law enforcement/military unmanned vehicle.

11. The unmanned vehicle of claim 9 wherein the actuator assembly is an electric actuator assembly.

12. The unmanned vehicle of claim 7 wherein:
the actuator assembly includes at least one reel assembly; and
the flexible strapping assembly includes a pin assembly positioned proximate at least one of the first and second distal ends.

13. The unmanned vehicle of claim 12 wherein:
the pin assembly is configured to releasably engage the at least one reel assembly; and
the actuator assembly is configured to rotate the at least one reel assembly when energized to wind at least a portion of the flexible strapping assembly about the reel assembly and tension the flexible strapping assembly.

14. The unmanned vehicle of claim 9 wherein the flexible strapping assembly is chosen from the group consisting of: a nylon flexible strapping assembly; a rubber flexible strapping assembly, a chain flexible strapping assembly, and a Kevlar flexible strapping assembly.

15. The unmanned vehicle of claim 9 wherein the object to be grasped is an explosive device.

16. An object grasping assembly for use on a vehicle, the object grasping assembly comprising:
a fixed jaw assembly;
a flexible strapping assembly configured to be positioned about at least a portion of the periphery of an object to be grasped, the flexible strapping assembly including:
a first distal end;
a second distal end;
a first pin assembly positioned proximate the first distal end; and
a second pin assembly positioned proximate the second distal end; and
an actuator assembly configured to releasably affix the object to the fixed jaw assembly, the actuator assembly including:
a first reel assembly configured to releasably engage the first pin assembly; and
a second reel assembly configured to releasably engage the second pin assembly.

17. The object grasping assembly of claim 16 wherein the vehicle is an unmanned vehicle.

18. The object grasping assembly of claim 17 wherein the unmanned vehicle is a law enforcement/military unmanned vehicle.

19. The object grasping assembly of claim 1 wherein the actuator assembly is an electric actuator assembly.

20. The object grasping assembly of claim 16 wherein the actuator assembly is configured to rotate the first and second reel assemblies when energized to wind at least a portion of the flexible strapping assembly about the reel assemblies and tension the flexible strapping assembly about the object.

21. The object grasping assembly of claim 16 wherein the flexible strapping assembly is chosen from the group consisting of: a nylon flexible strapping assembly; a rubber flexible strapping assembly, a chain flexible strapping assembly, and a Kevlar flexible strapping assembly.

22. The object grasping assembly of claim 16 wherein the object to be grasped is an explosive device.
